(19) United States
(12) Patent Application Publication
(10) Pub. No.: US 2009/0196441 A1
(43) Pub. Date: Aug. 6, 2009

(54) MP3 LOUDSPEAKER SYSTEM

(76) Inventors: Hao-Chin Pai, Taipei City (TW); Li-Teh Chen, Shen Keng Hsiang (TW); Siang-Hsiung Chen, Taipei City (TW); Min-Yung Hsu, Taipei City (TW)

Correspondence Address: LEONG C LEI, PMB # 1008, 1867 YGNACIO VALLEY ROAD, WALNUT CREEK, CA, 94598, US

(21) Appl. No.: 12/024,123

(22) Filed: Feb. 1, 2008

(51) Int. Cl. H04R 9/06

(52) U.S. Cl. 381/182

(57) ABSTRACT

A MP3 loudspeaker system is disclosed. The MP3 loudspeaker system comprises a main loudspeaker and a sub loudspeaker connected by signal cables. The loudspeaker has a flat configuration and the edge of the loudspeaker is provided with magnetic element such that the main loudspeaker and the sub loudspeaker attract each other. The lower section of the main and sub loudspeaker is provided with a folding section and a signal cable connector. The loudspeaker can be folded and stand with the folding section as a support. The signal cable connector is also functioned as the base support for the loudspeaker.

### BACKGROUND OF THE INVENTION

(a) Technical Field of the Invention

The present invention relates to a MP3 loudspeaker system, and in particular, a loudspeaker system that can be magnetically attracted and extended to stand.

(b) Description of the Prior Art

Conventional PC multi-media loudspeaker is a necessary device to a computer. However, the structure of this loudspeaker is only for the purpose of providing music, and the drawbacks of this loudspeaker are in appropriate size of the loudspeaker and its operation. An improvement on this loudspeaker is the smaller size loudspeaker for IPAI and MP3. The operation of the loudspeaker has not been improved, especially the size of the loudspeaker causes inconvenience in the course of transporting and storage. Accordingly, this conventional loudspeaker does not fulfill the actual needs of the public.

In view of the above, it is the object of the present invention to provide a MP3 loudspeaker system which mitigates the above drawback.

### SUMMARY OF THE INVENTION

The primary purpose of the present invention is to provide a MP3 loudspeaker system comprising a main loudspeaker and a sub loudspeaker having a flat configuration connected by a signal cable, characterized in that a folding section is provided to the external side at the lower section of the loudspeaker, and the folding section comprises a shaft, two lateral shaft sleeve, an elastic element, a positioning ratchet shaft sleeve and an external shaft sleeve, wherein the shaft passes through the hollow slot at the top end of the folding section, and of the lateral shaft sleeve, an elastic element and a positioning ratchet shaft sleeve and the other lateral shaft sleeve are mounted onto the shaft in sequence, and the front end of the shaft is locked by a locking nut, and the external end is positioned using the external shaft sleeve; the elastic element is positioned between the lateral shaft sleeve and the positioning ratchet shaft sleeve, and the positioning ratchet shaft sleeve is mounted onto the shaft the extension force produced by the elastic element urges the positioning ratchet shaft sleeve towards another shaft sleeve, at the same time the ratchet teeth of the other lateral shaft sleeve is constantly in engagement with the ratchet teeth of the positioning ratchet shaft sleeve; the lug section extended from the two shaft sleeve are locked at the locking slot of the folding section of the lower edge of the loudspeaker body, and thus linked to the loudspeaker body; a signal cable connector body has a bent structure having a front end as an insertion signal cable connector and the bottom end of the bent structure is a supporting face and a signal wire is extended out from the rear side of the bent structure which is connected with the loudspeaker, the supporting face can stand and becomes a supporting leg of the loudspeaker body.

Yet still a further object of the present invention is to provide a MP3 loudspeaker system, wherein the main loudspeaker and the sub-loudspeaker are of flat configuration, and a plurality of magnetic elements are provided at the edges of the loudspeaker such that the loudspeaker attracts each other, facilitating storage and carrying.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of the MP3 loudspeaker system in accordance with the present invention.

FIG. 2 is an exploded perspective view of the MP3 loudspeaker components of the present invention.

FIG. 3 is a schematic view of the slot of the folding section of the loudspeaker body of the present invention.

FIG. 4 is a schematic view showing the connection between the loudspeaker body and the folding section of the present invention.

FIG. 5 is a schematic elevation view of the loudspeaker body of the present invention.

FIG. 6 is a schematic view of the signal cable connector of the present invention.

FIG. 7 is a perspective view of an extended loudspeaker body of the present invention.

FIG. 8 is a schematic view showing the attraction of the loudspeaker in accordance with the present invention.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

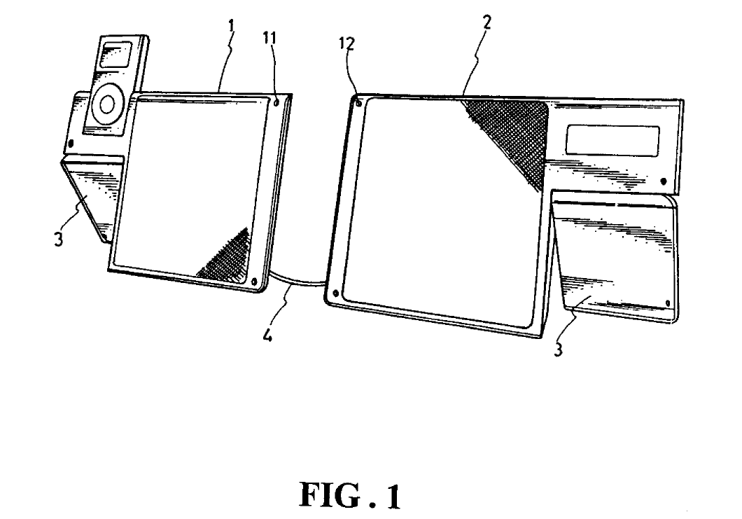

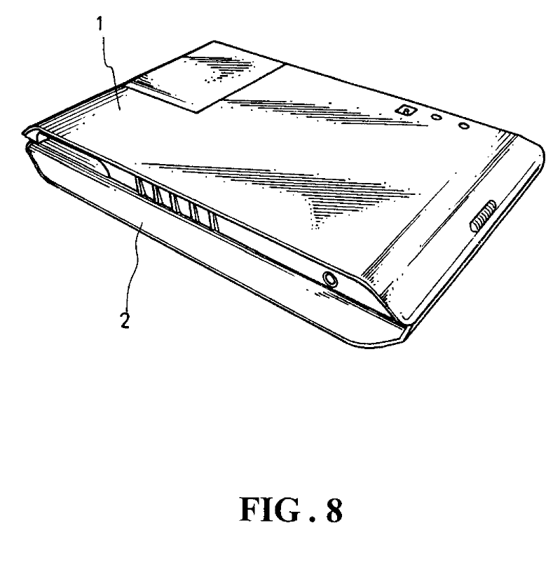

Referring to FIG. 1, there is shown a MP3 player loudspeaker system comprising a main loudspeaker 1 and a sub loudspeaker 2. The two loudspeaker are flat and a signal wire 4 connects the two loudspeakers 1, 2. The edges of the main speaker are provided with a plurality of magnetic elements 11, 12 which magnetically attract each other and therefore the two loudspeakers 1, 2 are attracted to each other, facilitating storage and transporting, as shown in FIG. 8.

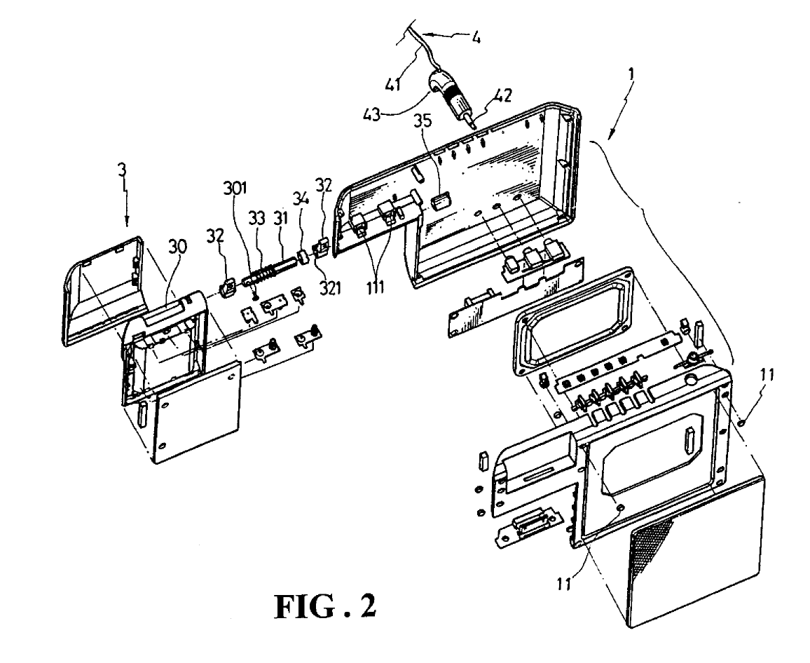

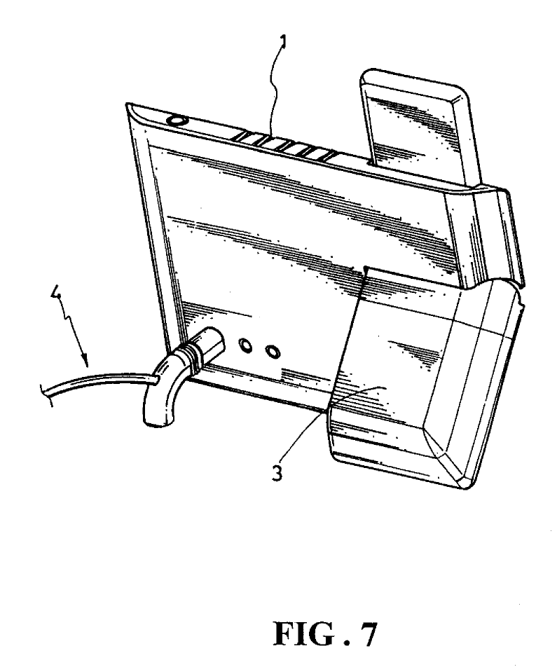

FIG. 2 shows an exploded view of the main loudspeaker 1 element. The structure of the main loudspeaker 1 is similar to that of the sub loudspeaker 2. The MP3 loudspeaker system is characterized in that there is provided a folding section 3 and a signal cable connector 40. The folding section 3 is positioned at the external side of the lower section of the loudspeaker 1 body and the folding section 3 is formed as a battery box for the storage of batteries. However, the most important mechanism of the folding section 3 is allowing the formation of an inclination angle such that the loudspeaker 1 is extended and stands alone, as shown in FIGS. 5 and 7.

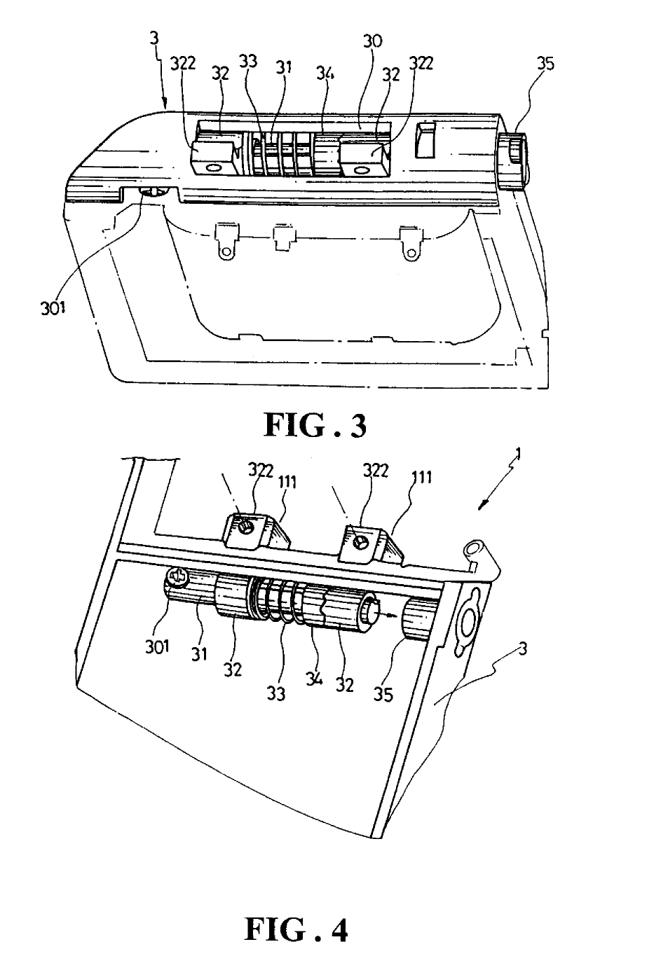

As shown in FIGS. 3 and 4, the folding section 3 is concealed and comprises a shaft 31, two lateral shaft sleeve 32, an elastic element 33, a positioning ratchet shaft sleeve 34 and an external shaft sleeve 35. The shaft 31 passes through the slot 30 at the top end of the folding section 3, and is then mounted in sequence with a lateral shaft sleeve 32, the elastic element 33, the positioning ratchet shaft sleeve 34 and the other shaft sleeve 32. Finally the front end of the shaft 31 is locked using a locking screw 301 and the external end of the shaft 31 is engaged by an external shaft sleeve 35 such that the shaft 31 becomes the connection and pivot element between the folding section 3 and the loudspeaker body 1.

The elastic element 33 is positioned between the lateral shaft sleeve 32 and the positioning shaft sleeve 34 and the extension force generated by the elastic element 33 urges the positioning ratchet shaft sleeve 34 to the other lateral shaft sleeve 32. At the same time, the ratchet 321 at the other lateral shaft sleeve 32 and the ratchet 341 of the positioning ratchet shaft sleeve 34 are constantly in engagement. Next, the positioning ratchet shaft sleeve 34 is in engagement at the shaft 31 and this will allow the positioning ratchet shaft sleeve 34 moves horizontally and not rotating. Further, the two lateral shaft sleeve 32 together with the extended lug sections 322, are locked at the locking slot 111 at the folding section at the lower edge of the loudspeaker body 1. Thus, when the folding section 3 is folded or adjusted, the two lateral shaft sleeve 32 rotates correspondingly, and the rotation is initiated by the extension of the elastic element 33 via the ratchet shaft sleeve 34 such that the entire folding section 3 can be adjusted to angle to support the loudspeaker body 1.

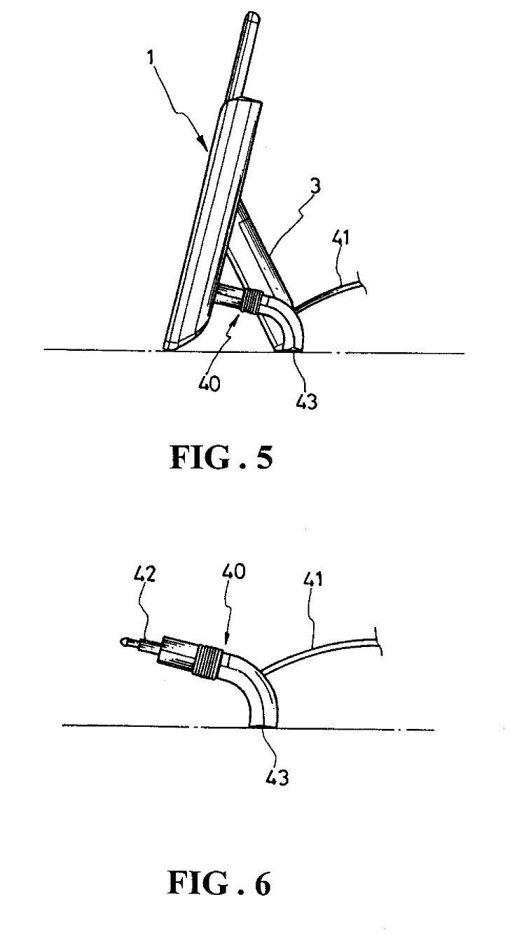

Referring to FIGS. 5 and 6, there is shown the signal cable 4 for connecting the main loudspeaker 1 and the sub loudspeaker 2. The two ends of the cable body 41 are the signal cable connector 40 which is a bending structure further forms an auxiliary support at one lateral side of the folding section 3 of the loudspeaker body 1 such that the loudspeaker body 1 can be extended and firmly stand.

The signal cable connector 40 is a bending structure having the front end as an insertion signal connector 42, and the bottom of the bending end is a support face 43, and a conduction wire 41 is extended from the rear end of the bending structure. After the loudspeaker body 1 is connected, the support face 4 of the signal cable connector 43 forms a support mechanism with the standing face, becoming another support leg at the folding section 3 of the loudspeaker body 1.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A MP3 loudspeaker system comprising a main loudspeaker and a sub loudspeaker having a flat configuration connected by a signal cable, characterized in that
a folding section is provided to the external side at the lower section of the loudspeaker, and the folding section comprises a shaft two lateral shaft sleeve, an elastic element, a positioning ratchet shaft sleeve and an external shaft sleeve, wherein the shaft passes through the hollow slot at the top end of the folding section, and of the lateral shaft sleeve, an elastic element and a positioning ratchet shaft sleeve and the other lateral shaft sleeve are mounted onto the shaft in sequence, and the front end of the shaft is locked by a locking nut, and the external end is positioned using the external shaft sleeve;
the elastic element is positioned between the lateral shaft sleeve and the positioning ratchet shaft sleeve, and the positioning ratchet shaft sleeve is mounted onto the shaft, the extension force produced by the elastic element urges the positioning ratchet shaft sleeve towards another shaft sleeve, at the same time the ratchet teeth of the other lateral shaft sleeve is constantly in engagement with the ratchet teeth of the positioning ratchet shaft sleeve; the lug section extended from the two shaft sleeve are locked at the locking slot of the folding section of the lower edge of the loudspeaker body, and thus linked to the loudspeaker body;
a signal cable connector body has a bent structure having a front end as an insertion signal cable connector and the bottom end of the bent structure is a supporting face and a signal wire is extended out from the rear side of the bent structure which is connected with the loudspeaker, the supporting face can stand and becomes a supporting leg of the loudspeaker body.

2. The MP3 loudspeaker system of claim 1, wherein the main loudspeaker and the sub-loudspeaker are of flat configuration, and a plurality of magnetic elements are provided at the edges of the loudspeaker such that the loudspeaker attracts each other, facilitating storage and carrying.
